(19) United States
(12) Patent Application Publication
(10) Pub. No.: US 2004/0064324 A1
(43) Pub. Date: Apr. 1, 2004

(54) Bandwidth expansion using alias modulation

(76) Inventor: David L. Graumann, Portland, OR (US)

Correspondence Address: KENYON & KENYON, 1500 K STREET, N.W., SUITE 700, WASHINGTON, DC, 20005, US

(21) Appl. No.: 10/214,098

(22) Filed: Aug. 8, 2002

(51) Int. Cl. G10L 19/00; G10L 21/00

(52) U.S. Cl. 704/500

(57) ABSTRACT

A method of transmitting an audio analog signal over limited bandwidth transmit channels include digitizing the analog signal and splitting the digitized signal into multiple channels. One channel is downsampled and anti-aliased. Another channel is high-pass filtered and downsampled. The channels are then encoded, and multiplexed together along with an alignment signal. The channels are then transmitted over limited bandwidth channels.

### FIELD OF THE INVENTION

One embodiment of the present invention is directed to digital data. More particularly, one embodiment of the present invention is directed to the bandwidth expansion of digital data over limited bandwidth channels.

### BACKGROUND INFORMATION

Analog audio data, such as voice and music, is frequently digitized and transmitted to devices, where it is then converted back into analog form. In addition to digitizing the data, the data is also typically compressed before being transmitted, because many transmission mechanisms have limited bandwidth capabilities.

For example, Bluetooth is a wireless transmission scheme in which multiple channels can be transmitted wirelessly between Bluetooth compatible devices. Unfortunately, each channel is limited to 4 kHz of bandwidth and therefore high frequency components of voice and other audio data above 4 kHz are typically cut-off when transmitted over a Bluetooth wireless channel.

For voice signals, this bandwidth limitation can have a negative effect. Specifically, the frequency components of voice above 4 kHz that may be cut-off on a Bluetooth channel, or any other bandwidth limited channel, can aid a listener in the intelligibility and naturalness of the reproduced voice. In addition, speech recognition algorithms can take advantage of higher frequency components above 4 kHz in order to enhance recognition accuracy.

Based on the foregoing, there is a need to transmit high bandwidth digital signals over limited bandwidth channels.

### BRIEF DESCRIPTION OF THE DRAWINGS

FIG. 1 is a block diagram of a transmitter in accordance with one embodiment of the present invention.

FIG. 2 is block diagram of a receiver in accordance with one embodiment of the present invention.

### DETAILED DESCRIPTION

One embodiment of the present invention is a method for transmitting a high bandwidth digital signal over multiple low bandwidth transmission channels by splitting the high bandwidth signal into two signals, and then aliasing the high frequency signals into a lower frequency. The two signals are then transmitted over two lower bandwidth channels and then are recombined and converted back into the high bandwidth signal.

One embodiment described below is in conjunction with the Bluetooth transmission scheme. In the original Bluetooth v1.1 specification, only toll quality speech is provided over the audio channels. The Bluetooth specification provides for three 64 kb/s channels of audio each covering the standard sub 4 kHz range. As discussed above, this is not ideal for speech recognition algorithms which often require a 5.5-8 kHz cut-off. The conventional method for resolving this would be to add a high sampling rate analog-to-digital (“A/D”) converter, and send twice as many bits in one channel. However, this is not possible because of the 64kb/s limit for each of the Bluetooth channels.

Although Bluetooth embodiments are described, other embodiments of the present invention can be implemented with any transmission scheme, wireless or otherwise, that has at least two data transmission channels. For example, embodiments of the present invention can use Integrated Services Digital Network (“ISDN”) as the transport layer. ISDN includes two or more limited bandwidth voice channels.

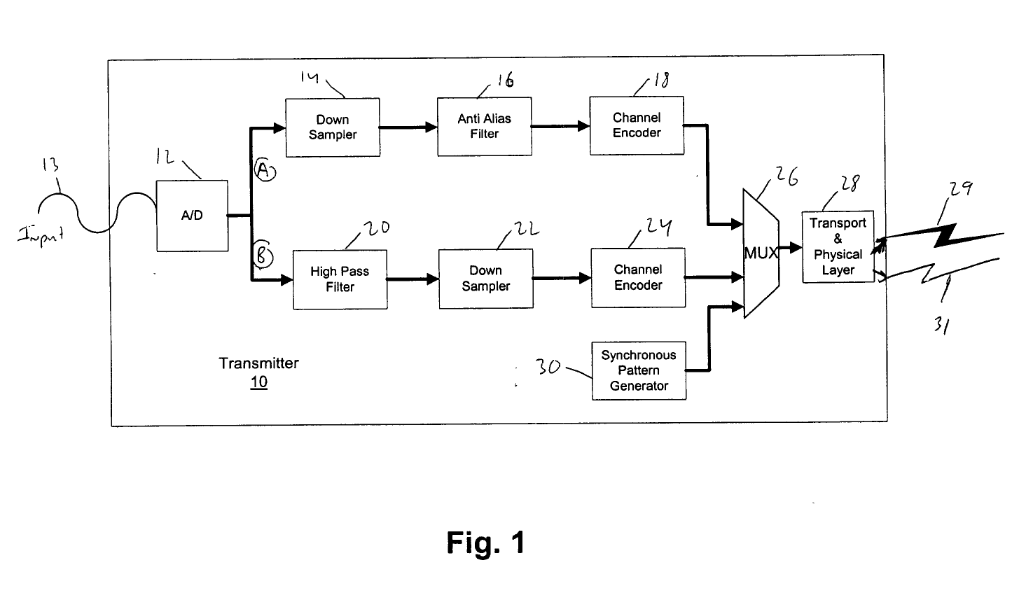

FIG. 1 is a block diagram of a transmitter 10 in accordance with one embodiment of the present invention. Transmitter 10 receives an analog input 13. In one embodiment, analog input 13 is a spoken voice. Analog input 13 is received by A/D converter 12 that digitizes the analog input in a known manner. In one embodiment, AID converter 12 has a sampling rate twice as fast as an A/D converter in a prior art device that is not splitting input signal 13 into two signals. Therefore, in a Bluetooth embodiment, A/D converter 12 has a sampling rate of 16 kHz, which is twice as fast as the typical A/D converter in a Bluetooth device which has a sampling rate of 8 kHz. Because the sampling rate is increased, higher frequencies of input signal 13 can be sampled and digitized, per the well-known Nyquist Theorem. For the purposes of this patent, the sampling rate of A/D converter 12 is referred to as the “A/D sampling rate”.

The output of A/D converter 12 is split into two separate channels (channels A and B) and input to devices coupled to A/D converter 12. On channel A, a down sampler 14 down samples its input to approximately half its input frequency. In one embodiment, down sampler 14 down samples a received 16 kHz signal to an 8 kHz signal using a 2:1 decimation. The output of down sampler 14 is received by an anti-alias filter 16 with a bandpass between 0−(A/D sampling rate)/4 (or 0-4 kHz in the described embodiment), thereby removing high frequencies. The output of anti-alias filter 16 on channel A is a digitized voice signal similar to that of prior art Bluetooth devices.

On channel B, a high-pass filter 20 filters the input with a bandpass between (A/D sampling rate)/4−(A/D sampling rate)/2 (or 4-8 kHz in the described embodiment). A down sampler 22 then down samples the signal by 2. The result is that all signals output from down sampler 22 become completely aliased into the lower bandpass window. This is done without frequency ambiguity because all 0−(A/D sampling rate)/4 (or 0-4 kHz in the described embodiment) within the original signal have been filtered out.

At the outputs of anti-alias filter 16 and down sampler 22 are two sampled audio channels A and B containing the lower and upper frequency ranges of the original signal sampled at twice the rate of the channel. These signals are then prepared to be transmitted over two or more limited bandwidth digital communication channels, such as Bluetooth wireless channels, to a destination location that will recombine the signals. Therefore, the signals are processes by channel encoders 18, 24. Channel encoders 18, 24 in one embodiment compress the signals so that they can be transmitted. In one embodiment, where the signals are transmitted over Bluetooth channels, channel encoders 18, 24 are encoded under G.711 (an International Telecommunication Union (“ITU”) compression standard) or a Continuously Variable Slope Delta Modulator (“CVSD”), which are tailored for the relevant Bluetooth frequency band. However, any suitable encoding scheme can be used.

Transmitter 10 further includes a synchronous pattern generator 30 which is used to synchronize and align channels A and B when they are eventually recombined at a receiver in order to correct any skew. Synchronous pattern generator 30 inserts a pattern into the transmitted channel. The pattern is known by a receiver of transmitted data. In one embodiment, with G.711 companding at encoders 18, 24, the least significant bit (“LSB”) is replaced with a spectrally white predetermined Pseudo-Noise sequence with a repeat rate longer than the maximum skew encountered for the transport. For isochronous channels on Bluetooth, 1024 bits can be used. When altering the LSB, the signal's fidelity can be compromised. However, in the presence of broadband acoustic noise, this does not present a problem.

Transmitter 10 further includes a multiplexor (“MUX”) 26 which combines channels A, B and the output of synchronous pattern generator 30 together. A transport and physical layer module 28 then adapts the signal to be transmitted over at least two of the appropriate transport channels as transmitted data 29 and 31. In the Bluetooth embodiment, the signal output from MUX 26 is adapted to be transmitted over two or more of the Bluetooth limited bandwidth wireless data channels.

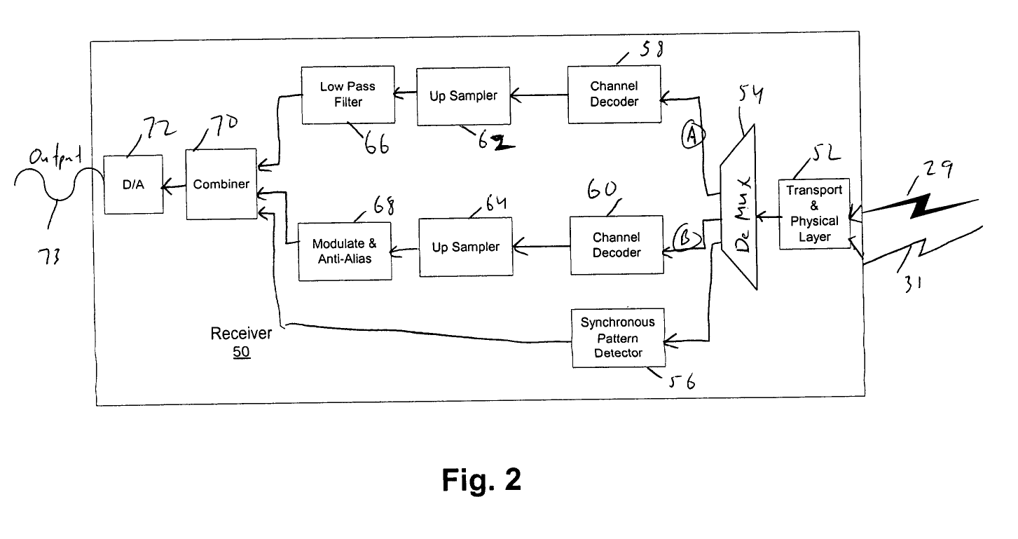

Transmitted data 29, 30 is ultimately received by a receiver. FIG. 2 is block diagram of a receiver 50 in accordance with one embodiment of the present invention. Receiver 50 includes a transport and physical layer module 52 that receives transmitted data 29, 30.

A demultiplexor 54 then separates the signal into channels A and B, and also sends the signal to a synchronous pattern detector 56 which works in tandem with synchronous pattern generator 30 to detect the patterns placed in the signal and to determine any skew between channels A and B. In one embodiment, the pattern is then exclusive-ORed with the received channel LSBs and summed at various lags. The alignment skew is identified as the minimum sum.

Channels A and B are decoded in channel decoders 58, 60, which work in reverse of channel encoders 18, 24. On channel A, the signal is then upsampled by an up sampler 62 by an amount inverse to the amount of down sampler 14. In one embodiment, the signal is upsampled by 2. Further on channel A, the signal is then low pass filtered by a low pass filter 66, which has the same bandwidth as anti-alias filter 16.

On channel B, the signal is upsampled by an up sampler 64, modulated to the original frequency range, and then band limited to remove the upper and lower aliased signals by an anti-alias modulator 68.

Channels A and B are then combined in a combiner 70, which also receives skew information from synchronous pattern detector 56 in order to properly align the signals. Combining is done by adding the two signals together after aligning the signals. Modulation does not alter the timing of the signals, but the band pass anti-aliasing filter does. The channels are therefore re-aligned by the filtering group-delays before combining. In one embodiment, the alignment method must be maintained throughout the connection. If alignment is lost, the lower frequency channels (i.e., channel A) are used without the higher frequency channels until alignment is regained.

The output of combiner 70 is then converted to analog by a digital-to-analog (“D/A”) converter 72, and the result is a high-quality analog reproduction of input signal 13 at output signal 73.

The alignment method disclosed uses a pattern generator and corresponding pattern detector in order to identify skew. However, any alignment and synchronization method that identifies and resolves skew can be used. The method of alignment and synchronization used may depend on the capabilities of the transport method for packet transmissions and packet loss handling. Alignment could rely on time slot locations of the physical layer methods between modules 28 and 52. In this case, alignment would most likely be implemented as custom hardware.

As described, one embodiment of the present invention overcomes problems of limited bandwidth channels by completely aliasing the higher bandwidth into the available channel region and then using two (or even three) of the channels to transmit this information over the link. For Bluetooth, this is done by altering the analog and A/D circuitry on the front-end, which is outside of the Bluetooth standard. This extends the utility of the hardware to facilitate higher quality speech signals for either communications or speech recognition applications.

Besides providing advantages for voice communication, embodiments of the present invention can also provide the advantage of increasing the fidelity of a stereo input channel of a recording device, such as a personal computer sound card or ultrasound sensing hardware. By sampling a mono audio signal on both the left and right channel of a stereo A/D, embodiments of the present invention can be used to double the bandwidth of the signal without increasing the sampling capabilities of the device. In this embodiment, a rigorous combiner need not be used because the time alignment will be rigidly maintained within the device.

One alternative embodiment for establishing channels A and B of transmitter 10 is to use two A/D converters sampling at the bandwidth of the Transport Bandwidth (for Bluetooth this is 8 kHz). Prior to digitizing the signal with the A/D converters, an analog filter can be applied. Traditionally this would be the typical anti-aliasing filter of ½ the A/D sampling rate. But for channel B this filter would be (A/D sampling rate)/4−(A/D sampling rate)/2. This is the same filter used in the one A/D converter embodiment shown in FIG. 1 (i.e., filter 20). The result of this process is that channel A and B are already downsampled to the transport channel bandwidth so that down samplers 14 and 22 are not needed. In addition, anti-alias filter 16 is now redundant because the signal was already band limited prior to digitization. The remaining components of transmitter 10 shown in FIG. 1 remain the same.

Several embodiments of the present invention are specifically illustrated and/or described herein. However, it will be appreciated that modifications and variations of the present invention are covered by the above teachings and within the purview of the appended claims without departing from the spirit and intended scope of the invention.

For example, the embodiments described divide channels A and B in the transmitter in half with one channel having a bandwidth of 0−(A/D sampling rate)/4, and another channel having a bandwidth of (A/D sampling rate)/4−(A/D sampling rate)/2. However, the bandwidth can be split up any number of arbitrary ways, depending on how many transmission channels are available. Therefore, if three limited bandwidth transmission channels are available, the bandwidth may be split into three channels having a bandwidth of 0−(A/D sampling rate)/6, (A/D sampling rate)/6−(A/D sampling rate)/3, and (A/D sampling rate)/3−(A/D sampling rate)/2.

What is claimed is:

1. A method of processing an audio analog signal comprising:
digitizing the signal at a first sampling rate;
splitting the digitized signal into a first channel and a second channel;
down sampling the first channel;
anti-aliasing the first channel;
high pass filtering the second channel;
downsampling the second channel;
multiplexing the first channel and the second channel; and
transmitting the multiplexed first channel and second channel over a third channel and a fourth channel.

2. The method of claim 1, further comprising:
channel encoding the first channel and the second channel.

3. The method of claim 2, further comprising:
generating a synchronizing pattern; and
multiplexing the pattern with the first channel and the second channel.

4. The method of claim 1, wherein the third channel and fourth channel are Bluetooth wireless channels.

5. The method of claim 4, wherein the sampling rate is approximately 16 kHz and the third channel and the fourth channel have a bandwidth of approximately 0-4 kHz.

6. The method of claim 1, wherein the first channel has a bandwidth of 0−(the first sampling rate)/2, and the second channel has a bandwidth of (the first sampling rate)/2−(the first sampling rate)/4.

7. The method of claim 1, wherein the second channel has high frequency signals aliased into a lower bandpass window.

8. The method of claim 1, further comprising:
demultiplexing the first channel and the second channel from the received third and fourth channel;
upsampling the first channel;
low pass filtering the first channel;
upsampling the second channel;
modulating and anti-aliasing the second channel;
aligning the first channel and the second channel; and
combining the first channel and the second channel.

9. The method of claim 8, further comprising:
converting a digital output of the combined first channel and second channel to an analog signal.

10. The method of claim 8, further comprising:
only converting the second channel to a digital output if the first channel and second channel can not be aligned.

11. A method of processing a digitized signal comprising:
splitting the digitized signal into a first channel and a second channel;
down sampling and anti-aliasing the first channel;
high pass filtering and down sampling the second channel;
channel encoding the first channel and the second channel; and
multiplexing the first channel, the second channel and an alignment signal into a transmitted signal; and
transmitting the transmitted signal over at least two transport channels.

12. The method of claim 11, wherein the alignment signal is a predetermined pattern.

13. The method of claim 11, wherein the alignment signal is a time stamp.

14. The method of claim 11, wherein the transport channels are Bluetooth wireless channels.

15. The method of claim 11, wherein the digitized signal is formed from an analog signal sampled at approximately 16 kHz.

16. The method of claim 11, further comprising:
demultiplexing the first channel and the second channel from the received transmitted signal;
upsampling the first channel;
low pass filtering the first channel;
upsampling the second channel;
modulating and band limiting the second channel;
aligning the first channel and the second channel using the alignment signal; and
combining the first channel and the second channel.

17. The method of claim 16, further comprising converting the combined first channel and second channel into an analog signal.

18. A digital data transmitter comprising:
an analog-to-digital converter;
a first channel coupled to said analog-to-digital converter comprising:
a first down sampler
an anti alias filter coupled to said first down sampler; and
a channel encoder coupled to said anti alias filter;
a second channel coupled to said analog-to-digital converter comprising;
a high pass filter;
a second down sampler coupled to said high pass filter;
a channel encoder coupled to said second down sampler; and
a multiplexor coupled to said first channel and said second channel.

19. The transmitter of claim 18, further comprising a synchronous pattern generator coupled to said multiplexor.

20. The transmitter of claim 18, further comprising a transport and physical layer coupled to said multiplexor.

21. A digital data receiver comprising:
a demultiplexor for receiving a transmitted signal;
a first channel coupled to said demultiplexor comprising:
a first channel decoder;
a first up sampler coupled to said channel decoder; and
a low pass filter coupled to said up sampler;
a second channel coupled to said demultiplexer comprising:
a second channel decoder;
a second up sampler coupled to said second channel decoder; and
an anti-alias modulator coupled to said second up sampler; and
a combiner coupled to said first channel and said second channel.

22. The receiver of claim 21, further comprising a pattern detector coupled to said demultiplexor.

23. The receiver of claim 21, further comprising a digital-to-analog converter coupled to said combiner.

24. A method of processing an audio signal comprising:
splitting the audio signal into a first channel and a second channel;
anti-aliasing the first channel;
high pass filtering the second channel;
digitizing the first channel;
digitizing the second channel;
channel encoding the first channel and the second channel;
multiplexing the first channel, the second channel and an alignment signal into a transmitted signal; and
transmitting the transmitted signal over at least two transport channels.

25. The method of claim 24, wherein the alignment signal is a predetermined pattern.

26. The method of claim 24, wherein the transport channels are Bluetooth wireless channels.
